(19) United States
(12) Patent Application Publication
(10) Pub. No.: US 2016/0194150 A1
(43) Pub. Date: Jul. 7, 2016

(54) TRASH CONTAINER

(71) Applicants: Robert J. Guarino, Lindenhurst, NY (US); Robert Romano, Levittown, NY (US)

(72) Inventors: Robert Romano, Levittown, NY (US); Robert J. Guarino, Lindenhurst, NY (US)

(21) Appl. No.: 14/815,539

(22) Filed: Jul. 31, 2015

(51) Int. Cl. B65F 1/06; B65F 1/14

(52) U.S. Cl. CPC B65F 1/068; B65F 1/1452

(57) ABSTRACT

An improved trash container having a base, a rear partition wall, and a front partition wall hingedly attached to the base to enable the front partition wall to pivot and rotate forward away from the rear partition wall. The trash container further incorporates a bracket member that connects the front partition wall and the rear partition wall, enabling the front partition wall to transition amongst a closed position, an extended position and a releasing position. In a closed position, the base, front partition wall and rear partition wall are connectively aligned and together define an internal cavity for holding a trash bag. In an extended position, the front partition wall is pivoted forward of said base and separated from direct contact with the rear partition wall to enable efficient and hassle-free removal of a filled trash bag from the container.

### FIELD OF INVENTION

The present application relates generally to a container for se in connection with discarding trash. More specifically, the invention relates to an improved trash container that enables the efficient removal of a loaded trash bag located within the improved trash container.

### BACKGROUND OF THE INVENTION

There are a multitude of conventional trash containers that exist in the marketplace. For example, in residential and office settings, many trash containers comprise a basic geometric configuration and cavity designed to accommodate a trash bag which is filled over a period of time. Existing trash containers often incorporate a pedal-operated lid that opens when a user steps on a pedal at the base of container, and closes when a user steps off the pedal. Despite the foregoing and other advances in trash container design, these devices fail to provide an effective means to enable a user o remove a filled trash bag from a container without extensive effort or other drawbacks. For example, with regard to trash containers having a basic geometric configuration (e.g., circular, rectangular) or a pedal operated lid, these containers are often subject to unwieldly trash bag removal. In particular, as a trash bag is filled during use, force is applied against the walls of a container, eliminating spaces between the bag and walls of the trash container. As an individual attempts to lift the bag from the trash container, a vacuum is often created inhibiting removal of the trash bag. The suction that is generated causes the trash container to be lifted up with the bag and prevents the bag from being removed from the container without holding the container down or ‘dancing’ the trash bag out of the container.

Trash containers, such as those disclosed in U.S. Pat. Nos. 8,820,568 and 5,901,872, have dealt with the foregoing and other drawbacks by incorporating a door that opens to permit removal of a trash bag from the side of the container instead of lifting the trash bag out over the open top end. However, providing a trash can with a door that swings open is generally not feasible for compact areas e.g., under a counter cabinet, beside a desk) or in tight corners where trash cans are often placed. Likewise, swinging doors can cause damage to surrounding surfaces and nearby furniture.

Other trash removal systems, such as one disclosed in U.S. Pat. No. 7,591,060, have also addressed some of the drawbacks in trash bag removal from trash cans. That system includes a flexible liner arranged within a trash can. When a trash bag placed within the can is filled to capacity, it forces the flexible liner against the internal wall of the trash can enabling the liner to slide upwardly with the trash bag when the trash bag is removed. Although such a system addresses some of the concerns and drawbacks of prior art trash cans, the system remains unwieldly.

Based on the foregoing, there is an ongoing need to provide a more versatile trash container which addresses the shortcomings of the prior art.

### SUMMARY OF THE INVENTION

In view of the deficiencies and drawbacks in the prior art, it is a primary object of the present invention to provide an improved trash container that facilitates removal of trash bags from the top of a container.

It is another object of the present invention to provide an improved trash container having a pivoting partition wall that pivots forward to reduce resistance when removing a trash bag.

It is a further object of the present invention to provide an improved trash container having a pivoting partition wall that pivots a controlled distance within a predetermined range to save space and reduce the unintended damage to nearby surfaces and objects.

Additional objectives of the present invention will be apparent fro the disclosure which follows.

In summary, the invention involves an improved trash container having a base, a front partition wall hingedly attached to the base to enable the front partition wall to pivot and rotate forward, and a rear partition wall that defines the rear of the trash container. The trash container further incorporates a bracket member connecting the front partition wall and the rear partition wall, enabling the front partition wall to transition amongst a closed position, an extended position and a releasing position. In a closed position, the base, front partition wall and rear partition wall are connectively aligned and together define an internal cavity for holding a trash bag. In an extended position, the front partition wall is pivoted forward of said base and separated from direct contact with the rear partition wall to enable efficient and hassle-free removal of a filled trash bag from the container.

### BRIEF DESCRIPTION OF THE DRAWINGS

The above-described and other advantages and features of the present disclosure will be appreciated and understood by those skilled in the art from the following detailed description and drawings of which

FIG. 1 is a front and left-side perspective view of the improved trash can of the present invention in a closed position;

FIG. 2 is a left side elevational view of the improved trash can of the present invention in a closed position;

FIG. 3 is a left side elevational view of the improved trash can with a front partition wall pivoting open towards an extended pivoting position;

FIG. 4 is a left side elevational view of the improved trash can with a front partition wail in an extended pivoting position;

FIG. 5 is a left side elevational view of the improved trash can with the front partition wall and fastening module in a releasing position;

FIG. 6 is a left side elevational view of the improved trash can with the front partition wall fully released;

FIG. 7 is a top plan view of the improved trash can of the present invention; and

FIG. 7A is a magnified view of the partition walls of the trash can forming a tongue and groove seal or connection.

### DETAILED DESCRIPTION OF THE INVENTION

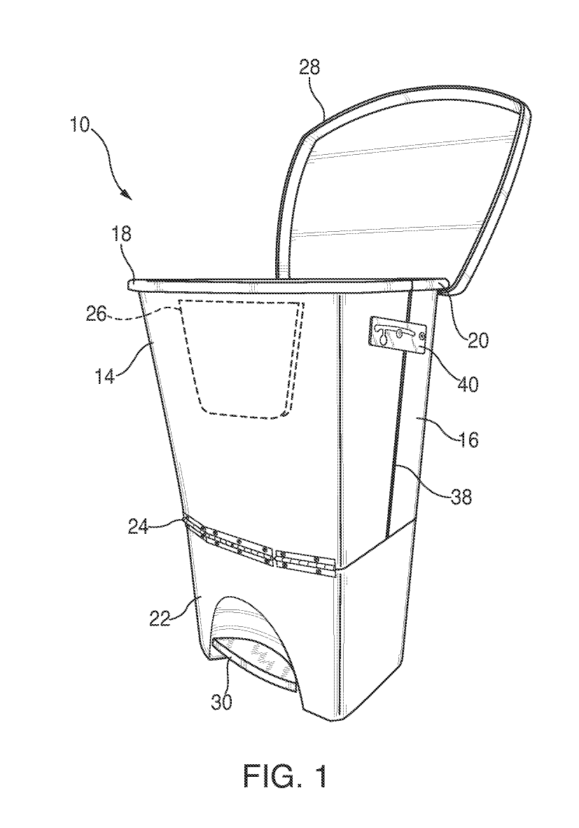

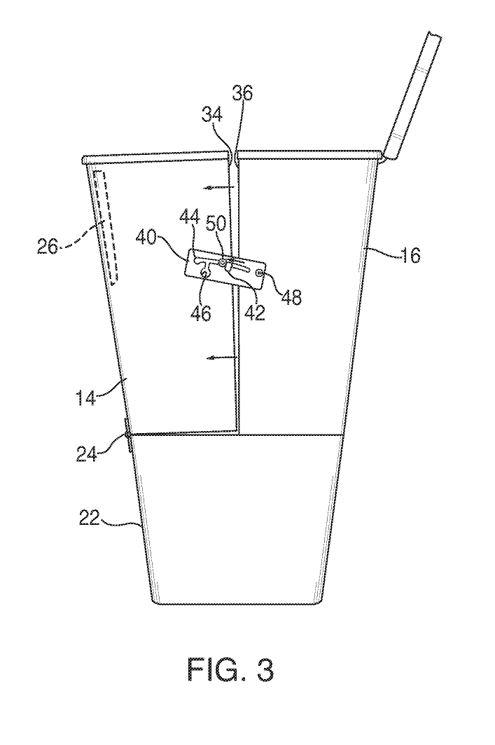

With reference to FIG. 1 through FIG. 7A, there is shown an improved trash container 10 of the present invention. Trash container 10 comprises an internal cavity 12 defined, in part, by a pair of walled partitions 14, 16, each having an upper rim 18, 20, respectively. Trash container 10 further comprises a base 22 into which internal cavity 12 extends. In a preferred embodiment front partition 14 is secured to base 22 with a trio of hinges 24, 24, 24 positioned on the exterior surfaces of front partition 14 and base 22, which enable front partition 14 to pivot and rotate forward, as shown in FIGS. 3 through 6.

With regard to the construction of trash can 10, it should be appreciated that more or fewer hinges may be utilized in connection with the present invention. Likewise, it should be understood that other attachment members may be utilized that enable front partition 14 to pivot forward in accordance with the present invention. Moreover, in a preferred embodiment, rear partition wall 16 is integrally molded to base 22, thus rendering rear partition wall 16 effectively immobile relative to base 22 and front partition wall 14. Alternatively, trash can 10 may be constructed with a rear partition wall 16 that is either removably attached to base 22 or hingedly attached to base 22, akin to front partition wall 14.

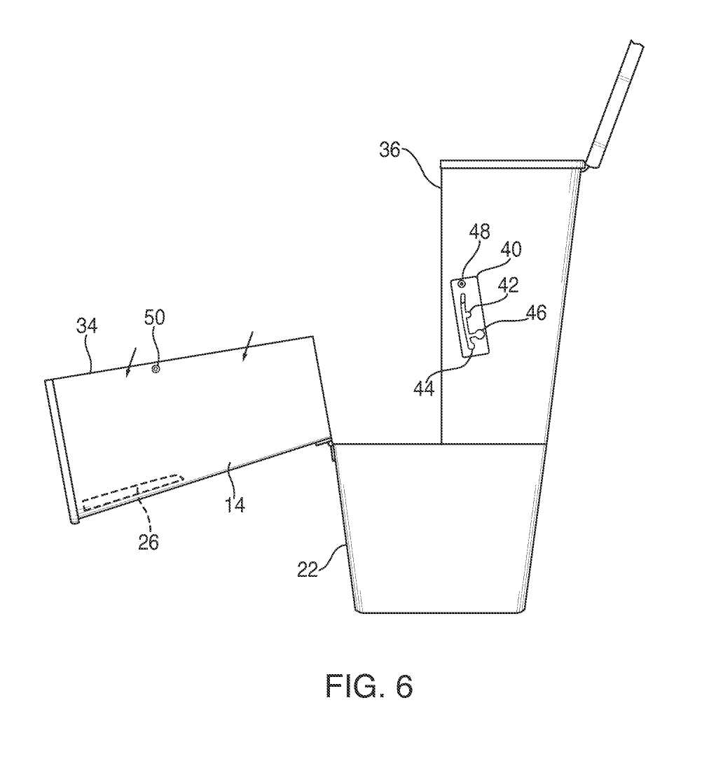

In a preferred embodiment, front partition 14 incorporates a pocket 26 adapted to hold a plurality of trash bags for use with trash container 10. To prevent trash bags contained within pocket 26 from falling out of pocket 26 when front partition 14 is in a fully released position, as shown in FIG. 6, pocket 26 is provided with a cover or other sealable opening. In a preferred embodiment, trash container 10 also incorporates a lid 28 that is operated by a pedal 30 to open and close the lid.

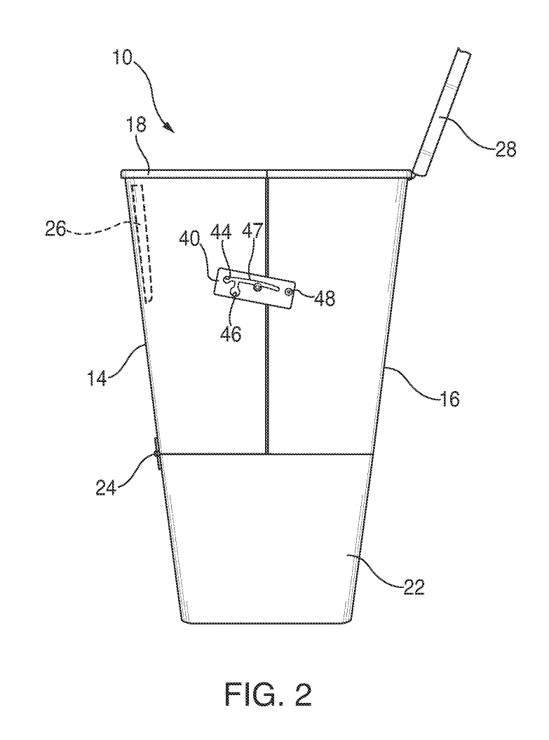

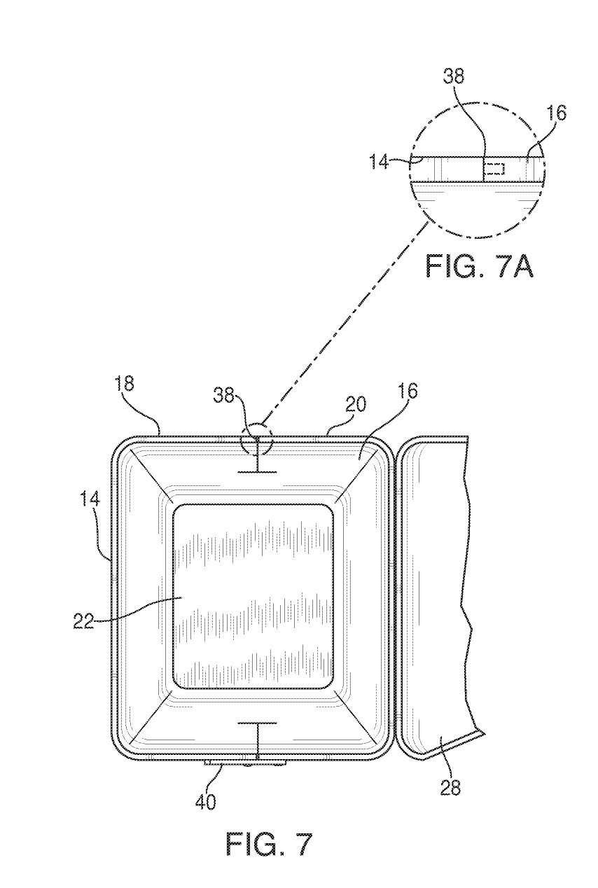

As shown in FIG. 1 and FIG. 2, trash can 10 is in a closed position. When trash can 10 is in a closed position, vertical partition edge 34 of front partition 14 and vertical partition edge 36 of rear partition 16 are aligned to form a tongue and groove connection or seal 38, as shown in FIG. 7A. It should be appreciated that vertical partition edges 36, 38 may be angled somewhat such that edges 36, 38 do not form a perpendicular angle when each meets base 22. Connection or seal 38 provides added stability when trash can 10 is in a closed position by securing sides 40, 40 of front partition 14 to rear partition 16 while the bottom of the front partition 14 is secured to base 22.

A preferred embodiment of trash can 10 incorporates a 3-way or triple recessed bracket member 40 positioned on either side of trash can 10 that enables front partition 14 to pivot a controlled distance forward. While a preferred embodiment incorporates two bracket members, it should be appreciated that a single bracket may be sufficient. Bracket member 40 comprises a first or closed position recess or slot 42, a second or extended position recess or slot 44 and a third or releasing position recess or slot 46. Connecting first slot 42, second slot 44 and third slot 46 is a channel network 47. In a preferred embodiment, the pivoting range of front partition 14 is defined by the distance between closed position slot 42 and extended position slot 44, wherein pivoting movement of front partition 14 is limited by bracket member 40 when bracket member 40 is engaged to front partition 14.

Referring again to FIG. 1 and FIG. 2, bracket member 40 is secured to rear partition 16 with bolt 48. Preferably, bracket member 40 is secured in a manner thud enables bracket member to rotate or pivot about bolt 48 when force is applied to bracket member 40 by a user. In a closed position, a dowel or pin 50—preferably with an enlarged head and narrower shaft—is positioned and secured in closed position slot 42 of bracket member 40. In a preferred embodiment, the relative dimensions and positioning of closed position slot 42 of bracket member 40 and pin 50 produce an audible ‘click’ and snap fasten when bracket member 40 is manually lifted upward against pin 50 and secured in a closed position. To release bracket member 40 and transition trash can 10 and partition wall 14 into a different position, sufficient downward force is applied by a user to position pin 50 in channel 47. Optionally, an elongated handle is applied to bracket member to enable a user o more easily manipulate the position of a bracket member and to transition between a closed position, extended position and releasing position.

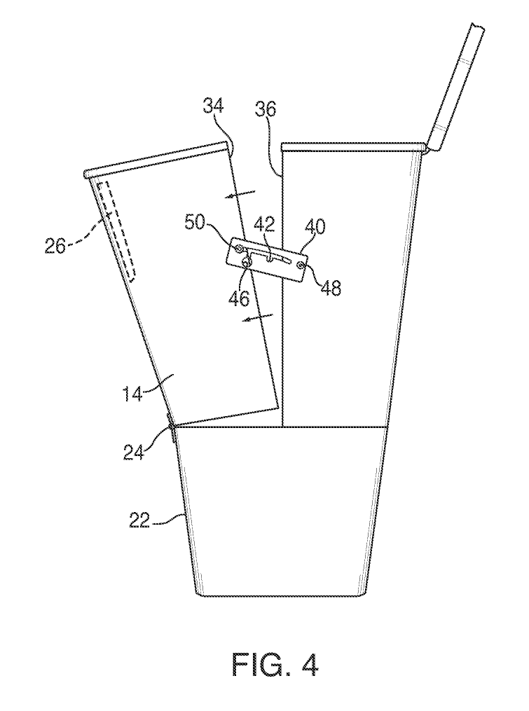

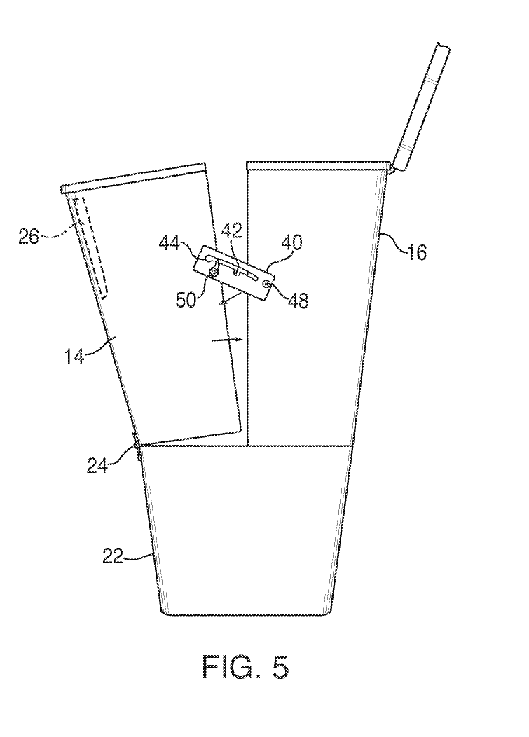

As shown in FIG. 3, pin 50 moves forward along channel 47 as front partition 14 pivots forward. At this point, a user may elect to continue to pivot front partition 14 forward to a fully extended position, as shown in FIG. 4, or to a releasing position, as shown in FIG. 5. When trash can 10 is in an extended position, pin 50 is positioned in second slot 44. Optionally, bracket member 40 and pin 50 also produce an audible ‘click’ when entering the extended position. When trash can 10 is in an extended position as shown in FIG. 4, front partition 14 pivots approximately 10-40 degrees forward. It should be appreciated that the pivoting range can be further extended or further limited by the length of channel 47 which defines a distance between first slot 42 and second slot 44. When trash can 10 is in an extended position, the separation that is produced between front partition 14 and trash bag reduces or eliminates any suction that would otherwise inhibit the removal of a filled trash bag from trash can 10 By the same token, by pivoting front partition 14 forward, the contents of trash bag are provided with additional space within which to settle which further facilitates removal of the trash bag.

As shown in FIG. 5, trash can 10 is in a releasing position when pin 50 is positioned in third slot 46. Placing trash can 10 in a releasing position enables front partition 14 to pivot forward, as shown in FIG. 6, unrestricted by bracket member 40. Restriction on the degrees of rotation is limited by hinges 24 (or the ground). By enabling front partition 14 to rotate forward, a user may more easily access that portion of internal cavity 12 defined within base 22 for cleaning or related objectives. In a preferred embodiment, the cavity defined within base 22. is at least 2-6 inches in height to accommodate any accumulation of liquid (or other refuse) that may exit from a trash bag if punctured.

In a preferred embodiment, third slot 46 defines a space that is large enough to accommodate the head of pin 50 to enable pin 50 to freely pass through the third slot of bracket member 40. By contrast, first slot 42, second slot 44 and channel 47 define a space large enough to accommodate the shaft of pin 50, but which is otherwise sized to prevent the bracket member 40 from being lifted over the head of pin 50.

In another preferred embodiment of the present invention, trash can 10 may incorporate, in conjunction with or instead of bracket member 40, a male and female clip fastener or buckle that keeps improved trash can 10 in a closed position. In such an embodiment, a male buckle end is positioned on one partition wall and a female buckle end is positioned on the other partition wall. When buckle ends are released from one another, front partition is permitted to pivot open as illustrated.

The accompanying drawings only illustrate a single embodiment of an improved trash container, its constituent parts, and method of use. However, other types and styles are possible, and the drawings are not intended to be limiting in that regard. Thus, although the description above and accompanying drawings contains much specificity, the details provided should not be construed as limiting the scope of the embodiment(s) but merely as providing illustrations of some of the presently preferred embodiment(s). The drawings and the description are not to be taken as restrictive on the scope of the embodiment(s) and are understood as broad and general teachings in accordance with the present invention. While the present embodiment(s) of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention. It should also be noted that the terms “first,” “second” and similar terms may be used herein to modify various elements. These modifiers do not imply a spatial, sequential, or hierarchical order to the modified elements unless specifically stated.

1. An improved trash container comprising:
a front partition wall and a rear partition wall that together form an upper section;
a base that forms a lower section, said front partition wall being hingedly attached to said base and adapted to pivot forward;
an internal cavity adapted to accommodate a standard trash bag, said internal cavity defined by said front partition wall, said rear partition wall and said base;
a bracket member connecting said front partition wall to said rear partition wall, and having a first closed position slot, a second extended position slot and a channel forming a path joining said first closed position slot and said second extended position slot;
a guiding pin, wherein when said guiding pin is positioned in said first closed position slot, said front partition wall and said rear partition wall are aligned and form a vertical seal; and
wherein when said guiding pin is in said second extended position slot, said front partition wall is pivoted forward.

2. The improved trash container of claim 1, further comprising a third releasing position slot, wherein said channel forms a path connecting said third releasing position slot to said first closed position slot and said second extended position slot.

3. The improved trash container of claim 1, said bracket member further comprising a handle to enable manipulation of said bracket member to transition said front partition wall between a closed position and an extended position.

4. The improved trash container of claim 1 further comprising a storage pocket positioned on said front partition wall in said interior cavity.

5. The improved trash container of claim 1, wherein said front partition wall pivots forward a maximum of 10-40 degrees when said guiding pin is in said second extended position slot.

6. The improved trash container of claim 1, said front partition wall comprising a first vertical partition edge and said rear partition wall comprising a second vertical partition edge, wherein said first vertical partition edge and said second vertical partition edge are aligned to form a seal when said front partition wall and rear partition wall are in a closed position.

7. The improved trash container of claim 6, wherein said first vertical partition edge and said second vertical partition edge form a tongue and groove seal.

8. An improved trash container comprising:
a base;
a front partition wall hingedly attached to said base;
a rear partition wall; and
a bracket member connecting said front partition wall and said rear partition wall;
wherein said rear partition wall and said front partition wall are positioned atop said base and are connectively aligned to form an internal cavity when said front partition wall is in a closed position, said internal cavity adapted to accommodate a standard trash bag; and
wherein said front partition wall is pivoted forward of said base and separated from direct contact with said rear partition wall when said front partition wall is in an extended position.

9. The improved trash container of claim 8, said bracket member having a closed position slot and an extended position slot, said closed position slot and said extended position slot connected by a channel.

10. The improved trash container of claim 9 further comprising a guiding pin that transitions between said closed position slot when said front partition wall is in said closed position and said extended position slot when said front partition wall is in said extended position.

11. The improved trash container of claim 10, said bracket member further comprising a releasing position slot connected to said closed position slot and said extended position slot by said channel.

12. The improved trash container of claim 11, said guiding pin adapted to transition to said releasing position slot when said front partition wall is in a releasing position.

13. The improved trash container of claim 12, wherein when said guiding pin is in said releasing position slot, said front partition wall is adapted to be selectively disengaged from said bracket member.

14. The improved trash container of claim 13, further wherein said front partition wall is adapted to pivot further beyond said extended position.

15. An improved trash container comprising:
a base;
a front partition wall hingedly attached to said base;
a rear partition wall; and
a bracket member connecting said front partition wall and said rear partition wall, said bracket member comprising a handle and a closed position slot, an extended position slot and a releasing position slot;
a guiding pin that transitions between said a closed position slot when said front partition wall is in a closed position, an extended position slot when said front partition wall is in an extended position, and a releasing position slot when said front partition wall is in a releasing position;
wherein said rear partition wall and said front partition wall are positioned atop said base and are connectively aligned to form an internal cavity when said front partition wall is in a closed position, said internal cavity adapted to accommodate a standard trash bag; and
wherein said front partition wall is pivoted forward of said base and separated from direct contact with said rear partition wall when said front partition wall is in an extended position.

16. The improved trash container of claim 15, said bracket member comprising a curved channel connecting said closed position slot and said extended position slot to enable said pin to transition between said closed position slot when said front partition wall is in a closed position and said extended position slot when said front partition wall is in an extended position.

17. The improved trash container of claim 15, said bracket member further comprising a handle to facilitate snap fastening of said guiding pin and unfastening of said bracket from said guiding pin.

18. The improved trash container of claim 15, said front partition wall and said rear partition wall forming a seal when said front partition wall is in a closed position.

19. The improved trash container of claim 18, said seal being a tongue and groove seal.

20. The improved trash container of claim 19, wherein said rear partition wall is integrally molded to said base.

21. An improved trash container, comprising:
a base;
a front partition attached to said base, said front partition having a front partition top edge, and a first pair of vertical side edges;
a rear partition attached to said base, said rear partition having a rear partition top edge, and a second pair of vertical side edges;
wherein when said front partition is in closed position, said front partition, said rear partition and said base define an internal cavity adapted to accommodate a standard trash bag, and said first pair of vertical side edges and said second pair of vertical side edges together form a pair of vertical side seals along the exterior surface of said trash container downward to said base from said front partition top edge and said rear partition; and
wherein when said front partition is in an extended position, said front partition pivots forward and said first pair of vertical partition edges each separate equidistantly from said second pair of vertical partition edges.

22. The improved trash container of claim 21, further comprising a bracket member connecting said front partition wall and said rear partition wall, said bracket member having a closed position slot, an extended position slot and a releasing position slot.

23. The improved trash container of claim 22, further comprising a guiding pin that transitions between said a closed position slot when said front partition is in a closed position, an extended position slot when said front partition wall is in an extended position, and a releasing position slot when said front partition wall is in a releasing position.
